(19) United States
(12) Patent Application Publication
(10) Pub. No.: US 2024/0328884 A1
(43) Pub. Date: Oct. 3, 2024

(54) GASEOUS FUEL IGNITION QUALITY TESTER, METHOD FOR DETERMINING FUEL IGNITION QUALITY

(71) Applicant: UCHICAGO ARGONNE, LLC, Chicago, IL (US)

(72) Inventor: SREENATH GUPTA, Naperville, IL (US)

(73) Assignee: UCHICAGO ARGONNE, LLC, Chicago, IL (US)

(21) Appl. No.: 18/129,784

(22) Filed: Mar. 31, 2023

(51) Int. Cl. G01L 23/22

(52) U.S. Cl. CPC G01L 23/227

(57) ABSTRACT

The invention provides a method for determining ignition quality in a fuel, the method including compressing a stoichiometric fuel mixture from a first pressure and temperature to a second temperature and temperature, and measuring the time between the attainment of the second pressure and temperature to auto ignition of the fuel mixture. Also provided is a device for measuring fuel ignition index, the device including a fuel mixture supply; a combustion chamber adapted to receive a stoichiometric fuel-mixture from the fuel-mixture supply; and a system for compressing the fuel mixture within the combustion chamber.

### CONTRACTUAL ORIGIN OF THE INVENTION

The U.S. Government has rights in this invention pursuant to Contract No. DE-AC02-06CH11357 between the U.S. Department of Energy and UChicago Argonne, LLC, representing Argonne National Laboratory.

### BACKGROUND OF THE INVENTION

### 1. Field of the Invention

This invention relates to ignition quality and more specifically, this invention relates to a device and method for determining ignition quality in fuel.

### 2. Background of the Invention

Methane Number is used by gas engine manufacturers as a loosely defined index (i.e., knock index) for auto-ignition of gaseous fuels. Methane Number (MN) is the methane concentration in a CH₄/H₂ mixture that has the same propensity to knock as a given gaseous fuel. It is a loosely defined metric for the auto-ignition, or knock propensity of fuel. Manufacturers rate their engines for MNs between 65 and 100.

Experimental determination of knock index of gaseous fuels has remained an arduous task requiring expensive and large instrumentation often involving a standardized variable compression ratio engine and specialized expertise. The gold standard for determining MN has been the Cooperative Fuel Research (CFR) engine. It is used extensively for testing, research, and instruction in the performance of fuels and lubricants for the internal combustion engine. It is a fixed asset (so not portable) that relies on engine speed in rpms, equivalence ratios and ignition timing. It works when the user varies compression radio until the fuel/air mixture starts knocking. CFR engines are large and cumbersome and require expertise to use.

Alternate procedures involve gas speciation and using mathematical correlations to derive a Methane Number. Gas speciation correlates gaseous species concentrations to MN. Measurement cycle time is approximately 20 minutes. There are inherent drawbacks with gas speciation. For example, natural gas is a mixture of 16 gaseous species, such that variables in testing results are inherent. Table 1 below provides a range of components and their concentrations found in natural gas.

TABLE 1
Natural Gas Components and Their Concentrations

| Component | Min. (%) | Max. (%) |
|---|---|---|
| CH₄ | 85 | 100 |
| C₂H₆ | 0 | 11 |
| C₃H₈ | 0 | 9 |
| i-C₄H₁₀ | 0 | 3 |
| n-C₄H₁₀ | 0 | 3 |
| i-C₅H₁₂ | 0 | 1 |
| n-C₅H₁₂ | 0 | 1 |
| n-C₆H₁₄ | 0 | 1 |
| n-C₇H₁₆ | 0 | 1 |
| n-C₈H₁₈ | 0 | 1 |
| n-C₉H₂₀ | 0 | 1 |
| n-C₁₀H₂₂ | 0 | 1 |
| H₂ | 0 | 30 |
| H₂S | 0 | 0.01 |
| H₂O | 0 | 0.1 |
| CO₂ | 0 | 30 |
| N₂ | 0 | 20 |
| O₂ | 0 | 3 |
| Siloxanes | 0 | 0 |

Earlier efforts have generated numerical correlations between MN and gaseous fuel composition. However, several studies have expressed doubts regarding the validity of MN as a representative knock index. This has resulted in each of the gas engine companies (CAT, Cummins, and Wartsila) defining their own MN correlations.

In-service degradation of pipeline steels and other fuel conduits, and the effect on the quality of fuel flowing there-through, is another reason to standardize auto-ignition indexes.

A need exists in the art for a device and method to standardize auto ignition indexes across the industry. The device and method should provide a well defined, rapid (less than 60 seconds), and easily determinable metric for MN/Knock Index that is applicable for a broad range of constituent gas concentrations, such as those ranges found in Table 1, supra.

### SUMMARY OF INVENTION

An object of the invention is to provide a device and method for determining fuel ignition quality.

Another object of the invention is to provide a device and method for accurately determining fuel ignition quality. A feature of the invention is that stoichiometric homogeneous fuel-oxidant mixtures are used instead of injecting gaseous fuel jets with ambient air. An advantage of the invention is that repeatability and accuracy of results are obtained inasmuch as effects due to local equivalence ratios and gas diffusivities are eliminated. (A local equivalence ratio is the ratio of fuel mass to oxidizer mass divided by the same ratio at stoichiometry for a given reaction.)

Still another object of the invention is to provide a device and system to standardize knock indexes (KI) for a fuel. A feature of the invention is establishing a representative knock index for a variety of fuels, including but not limited to natural gas, biogas, syngas, wood gas, landfill gas, hydrogen, and combinations thereof. An advantage of the invention is that it correlates KI with individual gas concentrations. This will optimize engine efficiency (minimize knock), and lower emissions. For example, a 2019 investigation by the Society of Automotive Engineers (SAE 2019-24-0008) indicated that a lower MN increased flame propagation speed and thus increased in-cylinder pressure and indicated mean effective pressure in a retrofitted natural gas spark ignition engine. In addition, a low MN increased the thermal efficiency despite the higher heat transfer to the surroundings. Also, a higher MN reduced the nitrogen-oxides emissions but increased unburned hydrocarbons (UHC) emissions.

Yet another object of the present invention is to provide a fuel ignition quality tester (IQT). A feature of the invention is that a stoichiometric fuel-air mixture is prepared in a static chamber and then compressed. A stoichiometric mixture is an ideal mixture or balanced mixture of fuel and oxidizer without the excesses of either remaining after combustion in which both the fuel and the oxygen in the air are completely consumed. (An exemplary stoichiometric ratio is 1:14.7 for a gasoline-air mixture.) An advantage of the invention is that it is safer and easier than state of the art systems while ensuring well controlled conditions.

Briefly, the invention provides a method for determining ignition quality, the method comprising compressing a fuel mixture from a first pressure and temperature to a second pressure and temperature; and measuring the time between the second pressure and temperature and auto ignition of the fuel mixture.

Also provided is a device for measuring fuel ignition index, the device comprising a fuel-mixture supply; a combustion chamber adapted to receive a fuel-mixture from the fuel-mixture supply; and a means for compressing the fuel mixture within the combustion chamber.

### BRIEF DESCRIPTION OF DRAWING

The invention together with the above and other objects and advantages will be best understood from the following detailed description of the preferred embodiment of the invention shown in the accompanying drawings, wherein:

FIG. 1 is a schematic elevational view of a compact system for establishing standardized knock indexes for specific fuels, in accordance with features of the present invention.

### DETAILED DESCRIPTION OF THE INVENTION

The foregoing summary, as well as the following detailed description of certain embodiments of the present invention, will be better understood when read in conjunction with the appended drawings.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

The following detailed description should be read with reference to the drawings in which similar elements in different drawings are numbered the same. The drawings, which are not necessarily to scale, depict illustrative embodiments and are not intended to limit the scope of the invention.

As used herein, an element or step recited in the singular and preceded with the word “a” or “an” should be understood as not excluding plural said elements or steps, unless such exclusion is explicitly stated. As used in this specification and the appended claims, the term “or” is generally employed in its sense including “and/or” unless the content clearly dictates otherwise.

Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

The invention provides a method for establishing standard knock indexes for specific fuels. A stoichiometric fuel-air mixture may be prepared (for example fully vaporized) in a static chamber and then introduced into a compression device. The compression device may feature a piston actuated in a myriad of ways (e.g., pneumatically, hydraulically, or via mechanical means) to adiabatically compress the gas mixture to high pressure and temperature. Preferably, a minute Rapid Compression Machine (RCM) is utilized to provide pneumatic actuation of the piston so as to keep testing durations to less than 2 minutes, and typically less than 60 seconds. Ignition delay is measured as the time delay between the end of stroke and start of combustion due to auto-ignition (e.g., a 5 percent pressure rise).

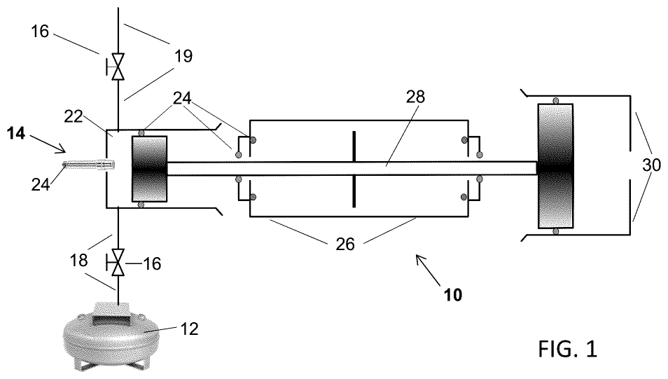

The invention further provides a gaseous fuel ignition quality tester (GaFIQT). FIG. 1 depicts the invented system, generally designated as numeral 10. FIG. 1 depicts a mixing chamber 12 (also considered herein as the “static chamber”) adapted to receive and homogeneously mix stoichiometric ratios of fuel and oxidant. The homogeneous mix generally is a fluid so can be either gaseous or liquid, or a combination of gas and liquid. For a given fuel, the stoichiometric ratio is not known ahead of time. From Table 2 infra, it can range from 1:2.38 for hydrogen to 1:30.94 for Butane. So, the technician will start from a very large number and scan a fuel-air (FA volumetric ratio is found providing the shortest combustion time. For example, if the fuel is similar to propane, which stores as liquid under pressure, it is prevaporized and mixed with air in the mixing (static) chamber 12. The technician may start from a F: A volumetric ratio of 30 and scan the ratio till the shortest combustion time or lack of oxygen in the exhaust are detected.

TABLE 2
FA Volumetric Ratio for Various Fuels

| | CxHyOz = ( )x + 0.25*y − 0.5*z) = Xi* 4.76 | | | | | |
|---|---|---|---|---|---|---|
| | Fuel | x | y | z | Xi | Fuel-Air Vol Ratio |
| Hydrogen | H₂ | 0 | 2 | 0 | 0.5 | 2.38 |
| Methane | CH₄ | 1 | 4 | 0 | 2 | 9.52 |
| Ethane | C₂H₆ | 2 | 6 | 0 | 3.5 | 16.66 |
| Propane | C₃H₈ | 3 | 8 | 0 | 5 | 23.8 |
| Butane | C₄H₁₀ | 4 | 10 | 0 | 6.5 | 30.94 |
| DME | C₂H₆O | 2 | 6 | 1 | 3 | 14.28 |
| Diesel | C₁₂H₂₃ | 12 | 23 | 0 | 17.75 | 84.49 |
| Gasoline | C₈H₁₈ | 8 | 18 | 0 | 12.5 | 59.5 |

When liquid phase or heterogeneous phase fuel mixtures are utilized, prevaporization hardware is positioned upstream of the system so as to fully gasify the fuel mixture prior to introduction into the mixing chamber 12. Typical fuel fluids include, but are not limited to methane, propane, butane, pentane, heptane, pipeline natural gas, hydrogen, syngas, biogas and combinations thereof. If the fuel stores as liquid under pressure (e.g., propane), it may be prevaporized and mixed with air in the mixing (static) chamber 12. The technician may start from a F: A volumetric ratio of 15 and scan the ratio till a the shortest propane combustion time is detected.

Suitable oxidant may consist of oxygen containing compounds such as air, oxygen gas, mixtures of O₂, N₂ and CO₂, and combinations thereof. As such, fuel mixtures comprise fuel oxidizer combinations, such as fuel-air mixtures, fuel-oxygen mixtures, and combinations thereof.

A combustion chamber 14 is positioned proximal to and downstream from the mixing chamber 12 and in intermittent fluid communication therewith. Fluid flow (of between 0.05 ml/sec and 5 ml/sec, and preferably between 0.1 ml/sec and 2 ml/sec) may be interrupted by the actuation of a fuel mix supply valve 16 disposed along a fuel mix supply line 18 extending from the mixing chamber 12 to the combustion chamber 14, such that the valve 16 is positioned between the mixing and combustion chambers. The mixture may be pre-pressurized, pre-heated, or a combination of these pretreatments. Initial or first pressures may range from 0.5 to 4 atm. Initial or first temperatures may range from 0° C. to 100° C. Second pressures (i.e., those present after compression) may range from 5 atm to 265 atm while second temperatures may range from 265° C. to 964° C.

An exhaust line 19 may be provided with a similar valve 16 to relieve pressure from the system. As with the fuel mix line 18, the exhaust line 19 is in fluid communication with the interior void defined by the combustion chamber.

The combustion chamber 14 comprises at least one wall that is movable relative to the other walls of the chamber. As such, the combustion chamber can be utilized as a constant volume chamber, or a variable volume chamber. As to the later configuration the volume may continuously change (e.g., decrease) during fuel compression. FIG. 1 depicts the movable wall as a piston 20, and the remaining walls 22 forming a cylinder adapted to receive the piston. The piston is in frictional engagement with the remaining walls via seals such as one or more O-rings 24. The seals serve to both maintain the pressure between the interior void defined by the combustion chamber and the ambient environment. The seals also prevent leakage of the fuel mixture from inside of the combustion chamber 14. The seals should prevent leakage up to 362 atm and also be thermally resistant up to 300 C.

A hydraulic chamber 26 provides the compressive force to the piston 20. The hydraulic chamber 26 is adapted to slidably receive a rod 28, wherein the rod has a distal first end attached to the proximal end of the piston 20 and a proximal second end in fluid communication with a compressor 30. A plurality of similar seals such as O-rings 24 prevent pressure loss at contact points between the rod 28 and the hydraulic chamber 26.

The compressor 30 imposes an axial force to the rod so as to cause the rod to bias the piston into the combustion chamber, thereby increasing pressure within the combustion chamber 14. The axial force may be the result of a positive pressure contacting a movable surface rigidly attached to the proximal end of the rod. The positive pressure may be mechanically applied, such as by a lever, or pneumatically or hydraulically applied, such as by fluid pressure.

In an embodiment, the system is 10 structured such that the longitudinal axes of the combustion chamber 14, the hydraulic chamber 26 and the compressor 30 are all coaxial to each other. The rod provides mechanical communication between these structures, and physically communicates with all three of them. The rod is seen also lying coaxially with the aforementioned structures. However, depending on space constraints a worm gear configuration may be utilized so as to situate the compressor 30 and/or hydraulic chamber at an angle (e.g., from 0 to 90 degrees) relative to the longitudinal axis of the combustion chamber 14 and/or the hydraulic chamber 26.

A pressure transducer 32 is provided and in fluid communication with the interior of the combustion chamber 14. The transducer monitors the pressure within the chamber.

In operation, the invention provides a method and device for determining ignition quality in a fuel. Specifically, the invention provides a method and device for compressing a fuel mixture from a first pressure and temperature to a second pressure and temperature; and measuring the time between the second pressure and temperature and auto ignition of the fuel mixture. The subsequent pressure and temperature values are determined via the application of thermodynamics, specifically Equations 1 and 2 below, to wit:

$${P}_{2} = {P}_{1} \cdot {( CR )}^{γ} , \qquad ( Equation 1 )$$

$${T}_{2} = {T}_{1} \cdot {( CR )}^{( γ - 1 )} , \qquad ( Equation 2 )$$

wherein CR=compression ratio and γ=(Cₚ/Cᵥ)=1.4 for air. These principles determine the relationship between initial pressure, initial temperature and those after compression.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” “more than” and the like include the number recited and refer to ranges which can be subsequently broken down into subranges as discussed above. In the same manner, all ratios disclosed herein also include all subratios falling within the broader ratio. One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

The embodiment of the invention in which an exclusive property or privilege is claimed is defined as follows:

1. A method for determining ignition quality, the method comprising:
a. compressing a fuel mixture from a first pressure and temperature to a second pressure and temperature; and
b. measuring the time between the second pressure and temperature and auto ignition of the fuel mixture.

2. The method as recited in claim 1 wherein the second pressure is higher than the first pressure.

3. The method as recited in claim 1 wherein a second temperature higher than the first temperature.

4. The method as recited in claim 1 wherein the fuel mixture comprises a homogeneous fuel-oxidizer mixture.

5. The method as recited in claim 1 wherein the fuel mixture is a fluid selected from the group consisting of methane, propane, butane, pentane, heptane, pipeline natural gas, hydrogen, syngas, biogas and combinations thereof.

6. The method as recited in claim 1 wherein the fuel mixture has a volume ranging from 27 ml to 108 ml.

7. The method as recited in claim 4 wherein a characteristic of the ignition quality is knock index and wherein the knock index is correlated with fuel concentrations within the fuel-oxidizer mixture.

8. The method as recited in claim 7 wherein knock index is determined within 10 seconds of combustion of the fuel-oxidizer mixture.

9. The method as recited in claim 4 wherein the fuel-oxidizer mixture is a combination of fuel and oxygen selected from the group consisting of fuel-air, fuel-oxygen, and combinations thereof.

10. The method as recited in claim 1 wherein the fuel mixture comprises a stoichiometric combination of fuel and oxidizer.

11. A device for measuring fuel ignition index, the device comprising:
a) a stoichiometric fuel-mixture supply;
b) a combustion chamber adapted to receive a fuel-mixture at a first temperature and first pressure from the fuel-mixture supply; and
c) a means for compressing the fuel mixture within the combustion chamber to a second temperature that is higher than the first temperature and to a second pressure that is higher than the first pressure.

12. The device as recited in claim 11 wherein the means for compressing fuel comprises a piston slidably communicating with the combustion chamber.

13. The device as recited in claim 11 wherein the fuel-mixture contains a reduced carbon fraction selected from the group consisting of methane, propane, butane, pentane, heptane, pipeline natural gas, hydrogen, syngas, biogas and combinations thereof.

14. The device as recited in claim 11 wherein the combustion chamber further comprises a means of ingress of the fuel-mixture and a means of egress of combustion exhaust.

15. The device as recited in claim 11 wherein the combustion chamber has a constant volume.

16. The device as recited in claim 11 wherein the combustion chamber has a variable volume.

17. The device as recited in claim 11 wherein the combustion chamber has a volume that continuously changes.

18. The device as recited in claim 11 wherein a fuel vaporizer is in fluid communication with the fuel mixture supply.

19. The device as recited in claim 13 wherein the fuel-mixture contains an oxidant selected from the group consisting of air, oxygen, ozone, and combinations thereof.

20. The device as recited in claim 11 wherein the fuel-mixture comprises a stoichiometric mixture of fuel and oxidizer.
